(19) United States
(12) Patent Application Publication
(10) Pub. No.: US 2009/0013167 A1
(43) Pub. Date: Jan. 8, 2009

(54) COMPUTER DEVICE, METHOD FOR BOOTING THE SAME, AND BOOTING MODULE FOR THE SAME

(75) Inventor: Chi-Lin Wang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/166,279

(22) Filed: Jul. 1, 2008

(30) Foreign Application Priority Data
Jul. 2, 2007 (TW) 96124014

(51) Int. Cl. G06F 9/00

(52) U.S. Cl. 713/2

(57) ABSTRACT

A method for booting a computer device can be applied to a basic input/output system (BIOS). Whether backup data of a master boot record (MBR) is stored in the BIOS is first determined. When the backup data of the MBR is not stored in the BIOS, actual data of the MBR is backed up to the BIOS; when the backup data of the MBR is stored in the BIOS, the actual data of the MBR is compared with the backup data of the MBR. Then the backup data is restored to MBR when the actual data is different from the backup data.

### CROSS-REFERENCE TO RELATED APPLICATION

This application claims the priority benefit of Taiwan application serial no. 96124014, filed on Jul. 2, 2007. The entirety of the above-mentioned patent application is hereby incorporated by reference herein and made a part of this specification.

### BACKGROUND OF THE INVENTION

1. Field of the Invention

The invention relates to a booting process of a computer device and, more particularly, to a booting process of a computer device achieving an automatic backup of a master boot record (MBR).

2. Description of the Related Art

Generally speaking, a basic input/output system (BIOS) is first executed when a computer device is booted. The first task of the BIOS is a power-on self test (POST) to determine whether hardware components of the computer device can work normally.

When the POST is finished, the BIOS tries reading the first sector of a hard disk, i.e. an MBR. Data of the MBR is loaded into a memory at location 0000:7C00 to be executed. Then data of a boot sector provided by an operating system (OS) is loaded to enter the OS.

Many boot strap sector viruses mainly destroy partitions of the hard disk, i.e. the MBR. Once a virus destroys the MBR, it is impossible to boot the computer device normally. A bootable disk is conventionally utilized to boot the computer device from a floppy disk drive. When the computer device enters a basic OS, a backup in a restoring magnetic disk or a compact disk is utilized to restore the computer device.

However, the floppy disk drive is gradually obsolete. In the modern computer devices, the floppy disk drives are not the standard equipment. Therefore, if the computer device failing to work normally is restored in the conventional way, a floppy disk drive has to be connected additionally. It is inconvenient.

Further, the restoring disk can also be utilized to restore the computer device. However, if the disk is lost, the computer device may fail to be restored. Then the whole system has to be reinstalled, which is time-consuming and laborious.

### BRIEF SUMMARY OF THE INVENTION

On objective of the invention is to provide a computer device, a boot module for the same, and a method for booting the same to achieve backing up data of an MBR automatically in a booting process, and then a restoring process can be easily executed when the MBR is destroyed.

A method for booting a computer device according to the invention can be applied to a BIOS. Whether backup data of an MBR is stored in the BIOS is first determined. When the backup data of the MBR is not stored in the BIOS, actual data of the MBR of the computer device is backed up to the BIOS; when the backup data of the MBR is stored in the BIOS, the actual data of the MBR is compared with the backup data. Then the backup data is restored to the MBR when the actual data is different from the backup data.

In one embodiment of the invention, the step of comparing the actual data of the MBR with the backup data of the MBR includes the following steps. A checksum of the backup data of the MBR in the BIOS is calculated as an original checksum. Further, a checksum of the actual data of the MBR is calculated as a new checksum. When the new checksum is not equal to the original one, the backup data of the MBR is restored to the MBR and the computer device is restarted. When the new checksum is equal to the original one, the OS is loaded.

The invention provides a boot module including a control unit, a storage device, and a basic operating unit. In one embodiment of the invention, both the storage device and the basic operating unit are coupled to the control unit. The basic operating unit has a BIOS. Further, the storage device has a MBR and is installed with an OS. The basic operating unit stores backup data of the MBR therein and may compare actual data of the MBR with the backup data before the OS is loaded into the computer device. When the actual data is different from the backup data, the basic operating unit restores the backup data to the MBR; when the actual data is the same to the backup data, the OS is loaded to complete booting the computer device.

The invention provides a computer device achieving an automatic backup in a booting process. The computer device includes a central processing unit (CPU), a control unit, a storage device, and a basic operating unit. In one embodiment of the invention, the CPU, the storage device, and the basic operating unit are all coupled to the control unit. The basic operating unit has a BIOS. Further, the storage device has a MBR and is installed with an OS. The basic operating unit stores backup data of the MBR therein and may compare actual data of the MBR with the backup data before the OS is loaded into the computer device. When the actual data is different from the backup data, the basic operating unit restores the backup data to MBR; when the actual data is the same to the backup data, the OS is loaded to complete the booting procedure.

According to the invention, data of the MBR can be backed up to the BIOS. Therefore, when the data of the MBR is destroyed, the backup data in the BIOS can be directly restored to MBR without an external storage medium.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a block diagram showing the inside of a computer device achieving an automatic backup in a booting process according to a preferred embodiment of the invention;

FIG. 2 is a flow chart showing a method for booting a computer device according to a preferred embodiment of the invention; and

FIG. 3 is a flow chart showing verifying an MBR according to a preferred embodiment of the invention.

### DETAILED DESCRIPTION OF THE EMBODIMENTS

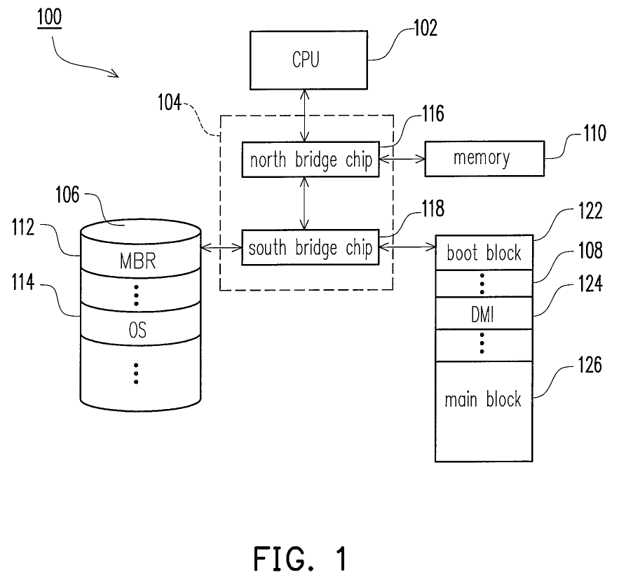

FIG. 1 is a block diagram showing the inside of a computer device achieving an automatic backup in a booting process according to a preferred embodiment of the invention. Please refer to FIG. 1. The computer device 100 includes a CPU 102, a control unit 104, a storage device 106, a basic operating unit 108, and a memory 110. The CPU 102 is coupled to the control unit 104, and is further coupled to the storage device 106, the basic operating unit 108, and the memory 110 by the control unit 104. The basic operating unit 108 may be a memory device such as a flash memory, and it has a BIOS. To facilitate description, the basic operating unit 108 is called the BIOS 108 thereinafter.

The control unit 104 mainly includes a north bridge chip 116 and a south bridge chip 118. The north bridge chip 116 is coupled to the CPU 102 and may be coupled to the memory 110 and the south bridge chip 118. Further, the south bridge chip 118 may be coupled to the storage device 106 and the BIOS 108.

In this embodiment, the storage device 106 may be, for example, a hard disk having an MBR 112 and at least provided with an OS 114. The MBR 112 refers to the first sector at the head of the hard disk and is located on side 0, track 0, sector 1 of the hard disk.

After the BIOS 108 completes a POST, the BIOS 108 tries reading data of the MBR 112. At this moment, the data of the MBR 112 is loaded into the memory 110 by the control unit 104 to be executed.

The MBR 112 is mainly divided into three partitions.

The first partition is a boot partition loader used for loading a bootable OS partition and transferring control to a boot sector. The boot partition loader is stored in the location from 000h to 1BDh and is about 446 bytes in size. The boot partition loader is first loaded to be executed besides the BIOS 108, and therefore some procedures such as multiple boot management procedure, boot strap sector viruses, hard disk encryption software work by the boot partition loader.

The second partition is partition data having a partition table. The partition data is stored in the location from 1BEh to 1FDh and is about 64 bytes in size. This partition can be further divided into four partitions.

The third partition is only 2 bytes in size and is used for verifying the MBR.

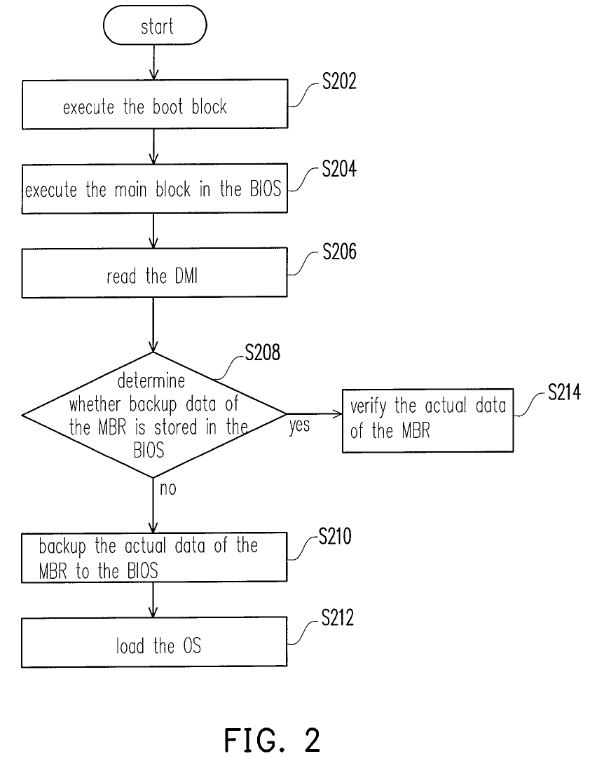

Accordingly, when the MBR 112 is destroyed by, for example, the boot strap sector viruses, the computer device 100 may fail to load the OS 114 to work normally. FIG. 2 is a flow chart showing a method for booting a computer device according to a preferred embodiment of the invention. It can effectively prevent the computer device 100 from failing to work normally when the MBR 112 is destroyed. Please refer to FIG. 1 and FIG. 2 together. The BIOS 108 mainly includes a boot block 122, a desktop management interface (DMI) 124, and a main block 126.

When the computer device 100 is booted, the BIOS 108 can first execute the boot block 122 as shown in step S202 and then execute the main block therein as shown in step S204. Further, during the POST, the BIOS 108 may read the DMI 124 as shown in step S206. In this embodiment, the BIOS 108 can execute the step S208 to determine whether backup data of the MBR 112 is stored therein.

When the backup data of the MBR 112 is not stored in the BIOS 108 (the indication of no as shown in step S208), actual data of the MBR 112 is backed up to the BIOS 108 as shown in step S210.

In the BIOS 108, the DMI 124 stores information of various devices on the system platform, such as the speed of the CPU 102, the size of the memory 110, or the utilization state of expansion slots. The size of the DMI 124 is generally set to about 4K bytes. However, the size of the space actually used is just about 1K-2K bytes. That is, the space with a size of about 2K-3K bytes in DMI 124 is not used. The size of the MBR 112 is usually smaller than 1K bytes, and actually it is about 512 bytes. Therefore, in some embodiments, the backup data of the MBR 112 may be stored in the DMI 124.

The unused space in the DMI 124 is large enough to contain the backup data of the MBR 112. Further, since most of the DMI 124 is static data, it can be easily achieved that the backup data of the MBR 112 is stored in the DMI 124 and the structure of the BIOS 108 is not affected. However, persons having ordinary skill in the art should know that, the invention is not limited to the location where the backup data of the MBR 112 is stored in the BIOS 108.

Although the backup data of the MBR 112 is stored in the DMI in the aforementioned embodiments, the invention is not limited thereto. Persons having ordinary skill in the art should know that the backup data of the MBR 112 may be stored in any reserved block in the BIOS 108. In a preferred embodiment, the reserved block is not modified when the BIOS 108 is updated.

Please continue to refer to FIG. 1 and FIG. 2. After the backup data of the MBR 112 is stored in the BIOS 108, the CPU 102 can execute step S212 to load the OS 114 by the control unit 104 to complete booting the computer device 100. In some alternative embodiments, the computer device 100 may be restarted after the step S210.

Further, in some alternative embodiments, the BIOS 108 can first determine whether a protecting function is enabled before the step S208. Just when the protecting function is enabled, the BIOS 108 executes the step S208. On the contrary, the BIOS 108 can skip the steps S208 and S210 to directly execute the step S212.

When the step S208 is executed, and it is determined that the backup data of the MBR 112 is stored in the BIOS 108 (the indication of yes as shown in step S208), step S214 is executed to verify the actual data of the MBR 112.

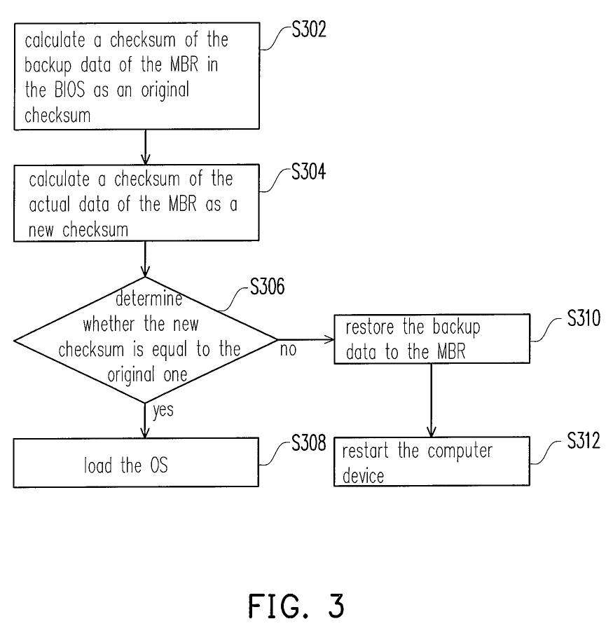

FIG. 3 is a flow chart showing verifying an MBR according to a preferred embodiment of the invention. Please refer to FIG. 1 and FIG. 3 together. When the backup data of the MBR 112 is stored in the BIOS 108, and the actual data of the MBR 112 is to be verified, a checksum of the backup data in the BIOS 108 can be calculated first as an original checksum as shown in step S302. Further, a checksum of the actual data of the MBR 112 also can be calculated as a new checksum as shown in step S304. Then step S306 can be executed to determine whether the new checksum is equal to the original one.

That the new checksum is equal to the original one (the indication of yes as shown in the step S306) indicates that the actual data of the MBR 112 is not destroyed. Then step S308 can be directly executed to load the OS 114. On the other hand, that the new checksum is not equal to the original one (the indication of no as shown in the step S306) indicates that the actual data of the MBR may be destroyed. Then the backup data of the MBR 112 in the BIOS is directly restored to the MBR 112 as shown in step S310 without other external storage medium. Therefore, the invention can fast and effectively restore the actual data of the destroyed MBR 112.

In some alternative embodiments, the computer device 100 can be automatically restarted as shown in step S312 after the step S310.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for booting a computer device, which is applied to a basic input/output system (BIOS), the method comprising the steps of:
determining whether backup data of a master boot record (MBR) is stored in the BIOS;
backing up actual data of the MBR of the computer device to the BIOS when the backup data of the MBR is not stored in the BIOS;
comparing the actual data of the MBR with the backup data of the MBR when the backup data of the MBR is stored in the BIOS; and
restoring the backup data to the MBR when the actual data is different from the backup data.

2. The method for booting a computer device according to claim 1, wherein before the step of determining whether the backup data of the MBR is stored in the BIOS, the method further comprises the steps of:
executing a boot block in the BIOS;
executing a main block in the BIOS; and
reading a desktop management interface (DMI) in the BIOS.

3. The method for booting a computer device according to claim 1, wherein after the step of backing up the actual data of the MBR to the BIOS or after the step of restoring the backup data to the MBR, the method further comprises the step of:
loading an operating system (OS).

4. The method for booting a computer device according to claim 1, wherein the step of comparing the actual data of the MBR with the backup data of the MBR comprises the steps of:
calculating a checksum of the backup data of the MBR in the BIOS as an original checksum;
calculating a checksum of the actual data of the MBR as a new checksum;
restoring the backup data of the MBR to the MBR and restarting the computer device when the new checksum is not equal to the original one; and
loading the OS when the new checksum is equal to the original one.

5. The method for booting a computer device according to claim 3, wherein after the step of executing the main block in the BIOS, the method further comprises the steps of:
determining whether a protecting function is started;
determining whether the backup data of the MBR is stored in the BIOS just when the protecting function is started; and
loading the OS directly when the protecting function is not started.

6. The method for booting a computer device according to claim 1, wherein the backup data of the MBR is stored in a DMI in the BIOS.

7. A boot module of a computer device, comprising:
a control unit;
a storage device coupled to the control unit, wherein the storage device has a MBR and is installed with an OS; and
a basic operating unit having a BIOS and coupled to the control unit, wherein the basic operating unit stores backup data of the MBR therein and compares actual data of the MBR with the backup data before the OS is loaded into the computer device,
wherein the backup data is restored to the MBR by the basic operating unit when the actual data is different from the backup data, and
the OS is loaded to complete booting the computer device when the actual data is the same to the backup data.

8. The boot module according to claim 7, wherein the storage device is a hard disk.

9. The boot module according to claim 7, wherein the basic operating unit is a memory device.

10. The boot module according to claim 9, wherein the memory device is a flash memory.

11. The boot module according to claim 7, wherein the BIOS comprises a boot block, a DMI, and a main block.

12. The boot module according to claim 11, wherein the DMI is used for storing the backup data of the MBR.

13. The boot module according to claim 7, wherein the control unit comprises a south bridge chip.

14. A computer device achieving an automatic backup in a booting process, comprising:
a central processing unit (CPU);
a control unit coupled to the CPU;
a storage device coupled to the control unit, wherein the storage device has a MBR and is installed with an OS; and
a basic operating unit having a BIOS and coupled to the control unit, wherein the basic operating unit stores backup data of the MBR therein and compares actual data of the MBR with the backup data before the OS is loaded into the computer device,
wherein the backup data is restored to MBR by the basic operating unit when the actual data is different from the backup data, and
the OS is loaded to complete booting the computer device when the actual data is the same to the backup data.

15. The computer device achieving an automatic backup in a booting process according to claim 14, wherein the storage device is a hard disk.

16. The computer device achieving an automatic backup in a booting process according to claim 14, wherein the basic operating unit is a memory device.

17. The computer device achieving an automatic backup in a booting process according to claim 16, wherein the memory device is a flash memory.

18. The computer device achieving an automatic backup in a booting process according to claim 14, wherein the BIOS comprises a boot block, a DMI, and a main block.

19. The computer device achieving an automatic backup in a booting process according to claim 18, wherein the DMI is used for storing the backup data of the MBR.

20. The computer device achieving an automatic backup in a booting process according to claim 14, wherein the control unit comprises:
a north bridge chip coupled to the CPU; and
a south bridge chip coupled to the north bridge chip and connecting the storage device and the BIOS.
